(19) United States
(12) Patent Application Publication
(10) Pub. No.: US 2026/0032053 A1
(43) Pub. Date: Jan. 29, 2026

(54) LEVERAGING PARTIALLY OBSERVABLE INFRASTRUCTURE FOR DATASET BUILDING

(71) Applicant: Dell Products L.P., Round Rock, TX (US)

(72) Inventors: Diego Vrague Noble, Pelotas (BR); Eduardo Vera Sousa, Niterói (BR); Karen Braga Enes, Belo Horizonte (BR); Karen Stéfany Martins, Belo Horizonte (BR)

(21) Appl. No.: 18/784,799

(22) Filed: Jul. 25, 2024

(51) Int. Cl. H04L 41/12; G06F 16/2455

(52) U.S. Cl. CPC H04L 41/12; G06F 16/24564; G06F 16/9024; H04L 41/16

(57) ABSTRACT

One example method includes receiving respective sets of node features from each edge node in a set of edge nodes of a network, identifying edge nodes in the set of edge nodes that contain datapoints corresponding to a specified class, using the datapoints to train an SH model, applying the trained SH model to the network, collecting datapoints from edge nodes in the specified class that were identified by the applying of the SH model to the network, when a threshold number of the edge nodes in the specified class has been identified by application of the SH model, collecting respective data points and features from each of those edge nodes of the specified class, and building a final dataset that comprises the edge nodes of the specified class, and their associated data points and features, that were identified by application of the SH model to the network.

### TECHNOLOGICAL FIELD OF THE DISCLOSURE

Embodiments disclosed herein generally relate to the construction of datasets. More particularly, at least some embodiments relate to systems, hardware, software, computer-readable media, and methods, for using a partially observable infrastructure to obtain data for a dataset.

### BACKGROUND

It is typically the case that when building a dataset, it can be quite difficult to find edge devices, attached to systems or devices that are collecting information, with similar characteristics, where the aim is to build a robust dataset of similar data for the eventual training of a machine learning model. There exist a variety of problems and challenges in this regard.

In more detail, a user may have only a partial view of the entire network in addition to a limited number of queries that can be made to uncover the nodes of interest in the network. The search must be intelligently guided so as not to waste queries in unpropitious network regions. That is, exploring the entire network domain may not be an intelligent, or practical, decision, due in part at least to the querying costs that are, or would be, associated with querying an entire network that may have thousands, tens of thousands, or more, nodes.

Following are some particular challenges that must be confronted when attempting to build a dataset that is suitably representative of a network environment, such as a distributed edge computing environment, for example. One of such challenges concerns the modeling of a distributed edge computing scenario as a partially observed graph. In particular, graphs can be complex structures that contain several types of information, such as node features, node labels and different edge meanings. Moreover, searching in partially observed graphs poses a more challenging problem than searching in traditional graphs. Thus, most of the traditional graph search algorithms are unsuited to a partially observed scenario.

Another challenge concerns searching for the best devices that also match similar geographic locations or any other domain feature while minimizing the number of queried nodes. For example, in a dynamic and distributed edge setting, most nodes and edges are unobserved and, as such, there is likely no access either to all information of such nodes, nor of nodes labels. Moreover, querying the entire network is unfeasible due to limited available time and resources. As well, the search process on partially unobserved networks is not trivial, as it becomes a ranking problem where choices must be made as to which node to be queried in the next iteration step to attempt to meet all the problem constraints. That is, because one area of interest may be to create datasets from different edge devices in similar domains, an aim may be to find only the devices that match these specific constraints.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a method that includes various steps of a selective harvesting algorithm.

FIG. 2 discloses aspects of an overview of a method according to one embodiment.

FIG. 3 discloses aspects of a first phase of a method according to one embodiment.

FIG. 4 discloses aspects of a second phase of a method according to one embodiment.

FIG. 5 discloses an example of a modeled network such as may be employed in connection with one embodiment.

FIG. 6 discloses aspects of a method according to one embodiment.

FIG. 7 discloses aspects of a computing entity configured an operable to perform any of the disclosed methods, processes, and operations.

### DETAILED DESCRIPTION OF SOME EXAMPLE EMBODIMENTS

Embodiments disclosed herein generally relate to the construction of datasets. More particularly, at least some embodiments relate to systems, hardware, software, computer-readable media, and methods, for using a partially observable infrastructure to obtain data for a dataset.

In general, example embodiments comprise methods for (1) modeling a distributed edge scenario as a partially observed graph, (2) searching for, and selecting, distributed systems and/or devices with particular characteristics, in a partially observed graph topology, and (3) defining, building, and using, a pipeline to manage distributed edge devices in a partially observed harvesting scenario to build datasets from similar domains. A method according to one embodiment may comprise any one, or more, of the aforementioned examples (1), (2), and (3).

In one embodiment, a method comprises operations including: a first phase that comprises building a node feature set that includes collecting data from one or more edge devices, obtaining representatives—or datapoints—from the data that represent similar domain features, and sending the respective feature sets of each node to a central server; and, a second phase that includes using, by the central server, the data from the nodes to train a selective harvesting (SH) algorithm, applying the trained SH algorithm to the network and, when a specified number of nodes from an identified class of interest are obtained, collecting datapoints and node features from those nodes and sending the datapoints and node features to the central server for use in generating a final dataset.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments is that a distributed edge scenario, such as a distributed computing environment, can be modeled as a partially observed, searchable, graph. An embodiment may search for, and identify, in a searchable partial graph, a set of systems or devices that possess one or more specified characteristics. An embodiment may obviate the need to search an entire graph or network when a user is seeking to identify those systems or devices in the graph or network that possess one or more specified characteristic(s). Various other advantages of one or more embodiments will be apparent from this disclosure.

### A. CONTEXT FOR AN EXAMPLE EMBODIMENT

The following is a discussion of aspects of an example context for various embodiments. This discussion is not intended to limit the scope of the claims or this disclosure, or the applicability of the embodiments, in any way.

### A.1 Graphs

As used herein, graphs are mathematical structures used to represent relationships, denoted in the graph as edges between entities, denoted in the graph as vertices or nodes for example. Due to the generality of graphs, these powerful structures can be used to model many problems. In many of these applications, the vertices, or nodes, of a graph can contain valuable information about the entities being modeled on these structures. This set of information about the modeled entities is referred to herein as the attributes of the nodes, or node attributes. In addition, the vertices of a graph may have special characteristics, such as labels, which make those vertices a target for identification and use in some tasks.

### A.2 Search in Graphs

Search in graphs includes the process of traversing a graph, a subgraph, or a set of interconnected nodes, to find one or more specific nodes or paths. Graph search includes a class of algorithms that systematically explore the nodes and edges of a graph, computing, or at least identifying, various node and/or edge properties of interest.

In many real networks, searching in a graph or accessing data associated with nodes and edges of the network is often difficult and querying nodes can have a steep cost in terms of parameters such as time, processing power, and memory and storage usage. In these scenarios, it is often the case that a large fraction of the data to be modeled is unobserved, and a user May have a limited budget, such as with respect to one or more of the aforementioned parameters, to perform queries. Moreover, a user may not be interested in the complete network, but only in a set of target nodes, that is, nodes with certain characteristics.

As an example, consider the problem of finding as many Facebook® users that share a particular taste in music as possible, starting from the friendship network of a specific user. In this example, Facebook® users are ‘nodes,’ friendship status are ‘edges’ and musical tastes are ‘attributes’ of a user. However, except for the Facebook® engineers themselves, access to this example networks is limited and it is thus impossible to query all nodes of the network. Daily budgets may apply for querying, for instance.

### A.3 Selective Harvesting

The problem of finding the largest number of target nodes for partially unknown network topologies, under a query budget constraint, is sometimes referred to as “Selective Harvesting” (SH), disclosed in in “F.e.a. Murai, ‘Selective harvesting over networks,’ Data Mining and Knowledge Discovery, vol. 32, pp. 187-217, 2018,” (“Murai”) incorporated herein in its entirety by this reference. SH may be stated as a graph search problem on partially unobserved network topology. However, due to the inherent complexity of the addressed problem, SH may be framed from other perspectives, such as an unbalanced data classification problem, a reinforcement learning task or as an anomaly detection problem, to enumerate a few.

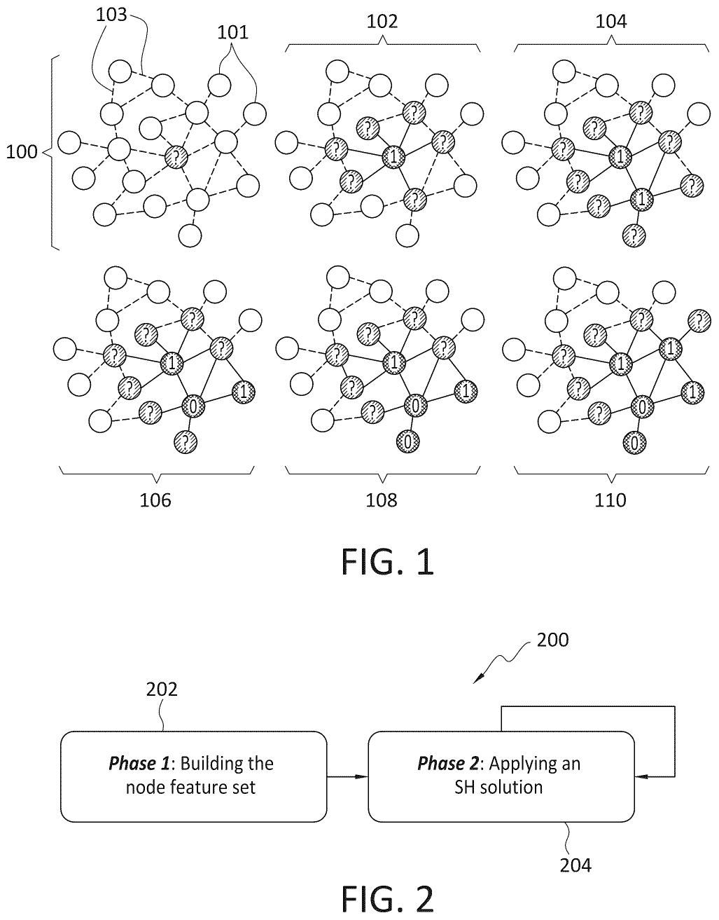

In SH, data is acquired through an online search or exploration of the graph, which may take the form of an evolving process that increases knowledge about the network as the search expands. At each step or iteration of the process, structural and non-structural information regarding topology, nodes and edge data is acquired. Since the networks are partially unobserved in SH, the set of queried nodes and their connections to the rest of the network compose all available information about the network. FIG. 1 illustrates 5 consecutives steps, or iterations, of an algorithm that performs an SH search procedure.

Particularly, FIG. 1 discloses some example operations of a search algorithm. In the example of FIG. 1, an initial state 100 may be defined in which little, or nothing, is known about the graph to be searched. In subsequent, sequential, operations 102, 104, 106, 108, and 110, information is gathered concerning the various nodes, generally designated at 101, and the edges, generally designated at 103, that connect two or more nodes 101. In the example of FIG. 1, black, gray, and white colors represent queried, unqueried, and unknown, nodes, respectively. Unqueried nodes are candidate nodes to be queried because they border with at least one queried node. Nodes that have no connections to queried nodes are unknown until they get to the border and, thus, become unqueried. Solid and dashed lines represent known and unknown edges, respectively. Further, “1” indicates target nodes and “0” indicates non-target nodes. Nodes marked with “?” indicate an unknown label for that node.

### B. OVERVIEW OF ASPECTS OF ONE EXAMPLE EMBODIMENT

One example embodiment is concerned with modeling a problem of finding the largest number of target nodes for partially unknown network topologies, under a query budget constraint, that is, SH, as a partially observed graph search. In one sense and embodiment, an edge network may be considered as a potential source of datasets obtained from an initial query.

One embodiment comprises the construction and use of a pipeline to search and select distributed devices with common domain features in a partially observed graph, so as to enable the building of datasets in similar domains. One embodiment may comprise a method that includes two phases, each of which is discussed in turn below.
Phase 1, building a node feature set, may begin with the generation of a respective feature set for each node edge device of the network. In one embodiment, each node represents an edge device connected to a set of sensors, IoT (internet of things) devices, and/or autonomous devices such as vehicles for example. Further, every node may have a respective set of attributes made up of different types of features such as, for example: representatives from the datapoints collected by the node; datapoint descriptors; and, data distributions.
Phase 2, may comprise applying an SH solution to collect the desired information and build the dataset. In more detail, an example phase 2 may comprise the following operations:
   1. receiving m node features from edge devices in a set of different edges devices to build training data in a central server, where m<<M, where M is the total number of nodes in the network—this operation may comprise collecting nodes features obtained from the device, where target nodes will the ones that contains datapoints from the class of edges that are being sought;
   2. using the data provided by the edges to train an SH algorithm;
   3. applying the pretrained model to the network considering a budget of k queries;
   4. collecting respective datapoints and nodes features from each of the queried nodes;
   5. checking if the number of collected nodes satisfy the threshold that defines the minimum amount of data and, if not:
      5.1 retraining the SH algorithm with the new data; and
      5.2 returning to 4. (above);
   6. collecting image and node features for each node;
   7. sending the image and node features to the central server; and
   8. building the final dataset.

As disclosed herein, embodiments may comprise various useful features and aspects, although no embodiment is required to possess any such feature or aspect. The following examples are illustrative.

An embodiment may comprise a method for modeling a distributed edge scenario as a partially observed graph. In many distributed edge scenarios, there may not be access to the entire network and querying all devices is generally infeasible besides not necessary. Thus, an embodiment may comprise a method that models a distributed edge scenario as a partially observed graph.

An embodiment may comprise a method to search for and select distributed devices with some characteristics in a partially observed graph topology. One embodiment of such a method automatically searches for distributed devices with some particular characteristics in a partially observed graph scenario, and then selects the most likely candidate to compose the device set to create the desired dataset.

As a final example, an embodiment may comprise a pipeline to manage distributed edge devices in a partially observed harvesting scenario to build datasets from similar domains. For example, an embodiment may model distributed edge devices as a partially observed graph in which a user intends to search for devices with some characteristics in similar, but different, domains, so as to build more robust datasets. By way of contrast, conventional approaches do not provide for the construction or use of a pipeline that manages distributed edge devices in a selective harvesting scenario.

### C. DETAILED DISCUSSION OF ASPECTS OF ONE EMBODIMENT

With reference now to FIG. 2, an example method 200 according to one embodiment is disclosed. As shown, the method 200 may comprise two phases, namely phase 1, or first phase 202, and phase 2, or second phase 204. In this example, the second phase 204 may be performed recursively, as discussed in more detail below.

### C.1 Phase 1 Of an Example Embodiment-Building the Node Feature Set

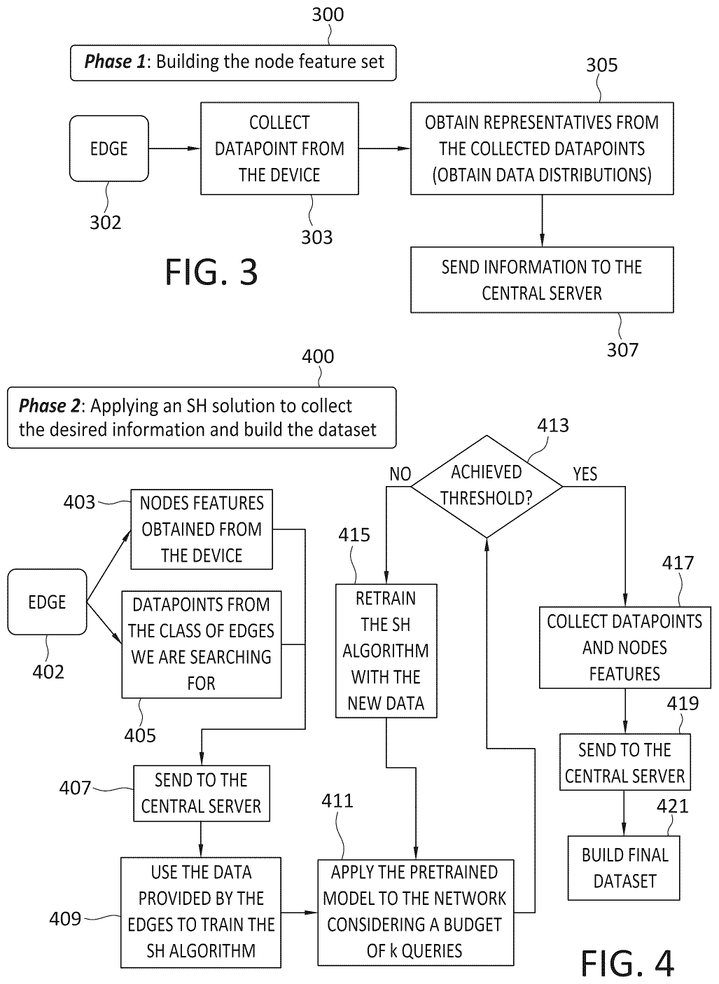

An objective of the first phase 202 is to build the node feature set for all edge devices and sensors nodes of the network. In one embodiment, the first phase 202 may comprise building the entire feature set for all nodes in the network, as shown in the example of FIG. 3.

Particularly, FIG. 3 discloses an example first phase 300 that may comprise various operations for building a node feature set. Thus, the example first phase 300 may be applied to each node in a group of nodes, where one example nodes is denoted at 302 in FIG. 3.

At the beginning of the first phase 330, an embodiment may establish what type of information is relevant to the SH model that is to be trained. In particular, each node 302 may have a set of attributes comprising three distinct types of features, namely: (i) datapoint descriptors; (ii) representatives obtained from the datapoints collected of each node; and (iii) data distributions.

Thus, the first step or operation of the method 300 may comprise collecting 303 descriptors from the edge device for each node of the network. Next, an embodiment may obtain, from each node, respective data distributions, and representatives of each of those data distributions. This is shown at 305 in FIG. 3. The representatives each comprise a datapoint that represent similar domain features for one or more nodes such as, for example, nodes located in the same geographical region. These representatives may be obtained using various different approaches. For example, an embodiment may use a clustering algorithm to cluster the full set of datapoints into groups. In one embodiment, a representative for each group may be the datapoint that represents a centroid of that group.

After the respective representatives have been obtained 305 from the collected sets of data points, the feature set of each node is sent 307 to a central server that may be configured and operable to communicate with each of the nodes. The feature sets may be used to enable mapping of similar domain features for each node of the network. With well-mapped characteristics for all nodes, the SH model may be able to better identify other nodes in the network that have similar features.

### C.2 Phase 2 Of an Example Embodiment-Applying a Selective Harvesting (SH) Solution

An objective of an embodiment of phase 2 is to apply an SH approach to collect the desired information from the network and build the dataset. FIG. 4 discloses an example embodiment of a second phase 400 that comprises application of an SH approach. As in the case of the example phase 1 shown at 300 in FIG. 4, the second phase 400 may be applied in connection with one or more nodes 402.

In an embodiment, the first part of the second phase 400 is to create a cold start set of nodes for the harvesting procedure to be implemented by the SH model. Creation of the cold start set may comprise collecting 403 node features of a very small sample of all edge device and sensor nodes to build an initial dataset for training the SH model. In addition to the collecting 403, an embodiment may also collect 405 information about what class of edges are being sought. In this sense, an example cold start set may comprise information for nodes of various different classes. An initial graph may be built using a simple random walk in the infrastructure, or the initial graph may be chosen as comprising a pre-selected set of nodes.

At 407, all information from the cold start set may be sent to the central server from the edge node(s). In one embodiment, a node harvesting process may begin with a subgraph comprising the central server and the nodes of the cold start set of nodes.

In a second part of the example second phase 400, an embodiment may use the initial cold start to train 409 an SH model. In an embodiment, the SH model may be applied 411 as a pretrained model to the rest of the network, that is, to the other nodes of the network that were not included in the cold start set. The application of the SH model, that is, the harvesting of nodes from a desired class of interest, may be performed using a budget of k queries as a constraint. Application of the SH model may be used for identifying and querying a maximum number of nodes from the desired class(es) of interest, and those nodes thus identified and queried may then be used to build a final dataset.

At the conclusion of the SH procedure 411, an embodiment may verify 413 whether or not the number of collected nodes satisfies a threshold that defines a minimum amount of data to be collected. This threshold, that is, this minimum amount of data, could be set as the minimum number of nodes of the desired class that are needed to build a robust dataset, for instance.

If it is determined 413 that the harvesting process 411 did not identify enough nodes to meet the threshold, an embodiment may append the data collected during the harvesting process 411 to the cold start set of features, and then rerun 415 the SH algorithm with a new budget size and then repeat the process until the number of queried nodes from the desired class meets the threshold. On the other hand, if it is determined 413 that the harvesting process satisfied the threshold, an embodiment may then collect 417 the data points and nodes features from the set of harvested nodes, send 419 the information to the central server, which may then build 421 the final dataset.

### D. EXAMPLE APPLICATION FOR ONE EMBODIMENT

As an example of an application for one embodiment, consider a scenario where several edge devices are connected to some hubs or switches which, in turn, are connected to a central server. One of the possible embodiments of such a scenario is having multiple cameras connected to edge devices in the same geographical region.

In this sense, the central server, hubs, and edge devices may be modeled as nodes in a graph and the edges of the graph are mapped as the distances, considering the network-related aspects, such as latency, for example, between the distinct types of nodes. Each device in the network stores, as node features, information regarding its domain. These devices can be surveillance cameras, for example. In one example implementation, one of these cameras is fixed at a certain point in the city and collects images from that specific angle and location. This location could be a street with cars, bicycles, pedestrians, or traffic signs, for example, which commonly undergo significant scene variations-such as due to rush hours, or weather conditions. In many cases, the data collected by an individual device is not enough to train machine learning models. Thus, it may be of interest to search for, and identify, those cameras collecting data in similar locations or situations, so that the data collected by the cameras may be used to create databases for training learning models.

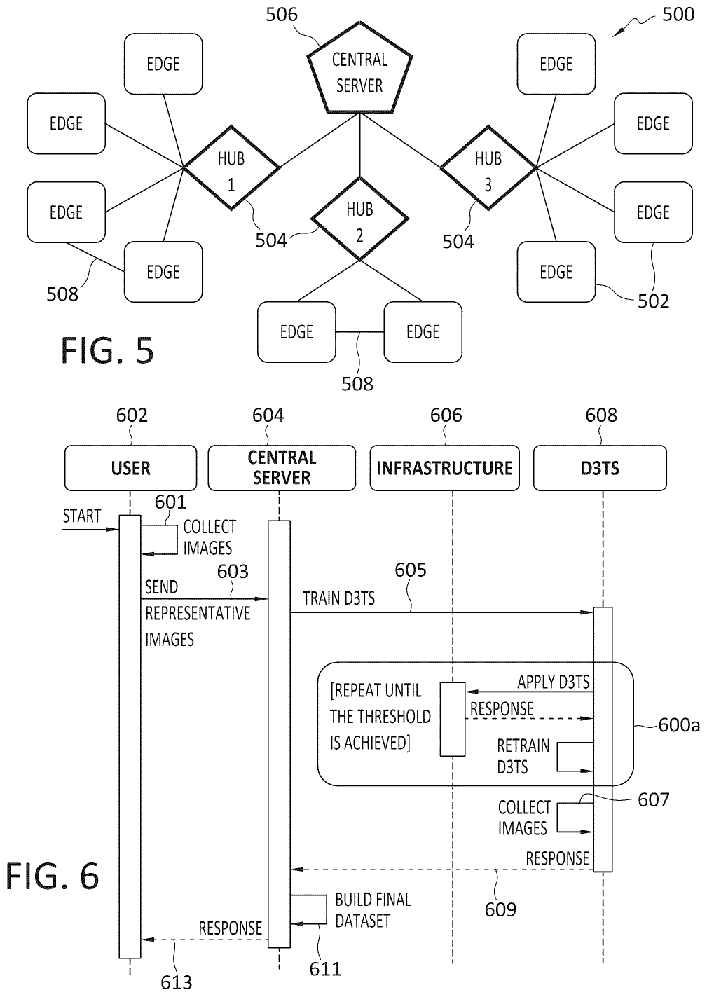

Turning now to the example of FIG. 5, a network schema 500 is disclosed. In this example, the network schema 500 comprises various edge devices 502 that are connected to hubs 504, or switches which, in turn, are connected to a central server 506. As a result of this architecture, the central serv 506 is able to communicate with each of the edge devices 502 by way of one of the hubs 504. Further, some edge devices 502 may be directly connected to other edge devices 502, such as by way of a connection 508.

Following are some further characteristics of this example network schema 500.
(i) the central server 506 knows the connections to the hubs 504—however, the hubs 504 do not contain information about the edge devices 502 connected to them;
(ii) hubs 504 aggregate multiple communication channels used by edge devices 502 or other lesser hubs—the hubs 504 do not contain information about all the devices connected at a given; moment-further, edge devices 502 can be connected to each other without being directly connected to a hub 504, as in the example of a ‘neighborhood within city’ concept; and (i) edges 508 represent network connections between two edge devices 502—the edges 508 may contain cost information associated with data traffic on the network, for example.

### D.1 An SH Approach

The Murai reference discusses some methods that can be adapted to solve a harvesting problem. In addition, those authors proposed the Directed Diversity Dynamic Thompson Sampling—or D3TS, a Multi-Armed Bandit (MAB) algorithm for non-stationary stochastic processes that combines different classifiers and intelligently selects a classifier at each step to decide which neighbor to query next in a harvesting search scenario.

At present however, there are few related works focusing on approaches to solve the SH problem. For example, “LaRock, Timothy and Sakharov, Timothy and Bhadra, Saheli and Eliassi-Rad, Tina., ‘Reducing network incompleteness through online learning: A feasibility study,’ in The 14th International Workshop on Mining and Learning with Graphs, 2018” (“LaRock”), incorporated herein in its entirety by this reference, presents a framework called Network Online Learning (NOL), a flexible online linear regression model within an explore vs. exploit framework for learning to grow an incomplete network towards a given objective, for example, increasing a number of observed nodes. Additionally, an alternative approach to SH was proposed in “Morales, Peter and Caceres, Rajmonda Sulo and Eliassi-Rad, Tina., ‘Deep Reinforcement Learning for Task-Driven Discovery of Incomplete Networks,’ in Proceedings of the Eighth International Conference on Complex Networks and Their Applications, 2020” (“Morales”), incorporated herein in its entirety by this reference. In particular, Morales proposes an algorithm called Network Actor Critic (NAC), a deep reinforcement learning model that allows offline training. This approach leverages a Markov Decision Process formulation of Reinforcement Learning that is network state-aware and estimates offline models of network discovery strategies and node utility. The following section comprises a brief description of D3TS as one, but not the only, approach that may be applied to solve SH search problem.

### D.1.1 Directed Diversity Dynamic Thompson Sampling-D3TS Algorithm

Directed Diversity Dynamic Thompson Sampling, or ‘D3TS,’ is a classifier for SH. D3TS is a Multi-Armed Bandit (MAB) algorithm for non-stationary stochastic processes that combines different classifiers and intelligently selects a classifier at each step to decide which neighbor to query. This approach differs from ensemble techniques at least in that classifier responses are not combined.

D3TS adapts Dynamic Thompson Sampling (DTS) algorithm proposed for MABs with non-stationary distributions to the SH problem. DTS is based on the Thompson Sampling (TS) algorithm for stochastic MABs, where binary outcomes associated with each arm are modeled as Bernoulli trials. The uncertainty on the probability parameter associated with each arm k is typically modeled as a Beta (Beta (αk, βk)) distribution. The Beta distribution is the conjugate prior for the Bernoulli distribution, thus providing computational savings on Bayesian updates. TS performs exploration by choosing arms probabilistically, according to samples drawn from the corresponding distributions. See Murai.

### D.2 Sequence of Operations According to One Embodiment

With attention now to FIG. 6, a sequence diagram 600 is disclosed that illustrates various entities and operations, according to one embodiment. It is noted that the highlighted region 600a portrays the example method disclosed in FIG. 4. In the example of FIG. 6, a user 602 may interact with a central server 604 which may communicate with an infrastructure 606, such as an edge environment for example, and an SH classifier 608, such as D3TS for example.

The example method disclosed in FIG. 6 may begin when the user collects 601 respective information from one or more edge devices, such as photographic images for example, concerning a specific situation, or domain, and then sends 603 these images together in a request to the central server 604. The central server 604 then uses these images to perform the initial training 605 of the D3TS algorithm. Note that no restriction is made with respect to where the SH classifier 608 is running, whether it is locally or not, thus, the SH classifier 608 appears as an individual component in the example of FIG. 6. The SH classifier 608 may iteratively perform the search for new nodes and hence expanding the uncovered network until the threshold is achieved, as indicated at 600a. At such point, all the images, or other information, is collected 607 from the selected edge devices that were found and a response is sent 609 by the SH classifier 608 back to the central server 604. The central server 604 may then use the information received from the SH classifier 608 to build 611 the dataset as requested and, finally, the central server 604 may then send 613 this dataset to the user 602, which may comprise a human and/or a computing entity, that initiated the process.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. FURTHER EXAMPLE EMBODIMENTS

Following are some further example embodiments. These are presented only by way of example and are not intended to limit the scope of this disclosure or the claims in any way.

Embodiment 1. A method, comprising: receiving respective sets of node features from each edge node in a set of edge nodes of a network; identifying those edge nodes in the set of edge nodes that contain datapoints corresponding to a specified class of edge nodes;
using the datapoints to train a selective harvesting (SH) model; after the SH model has been trained, applying the SH model to the network, wherein the applying is constrained by a budget of k queries; collecting datapoints from edge nodes in the specified class that were identified by the applying of the SH model to the network; when a threshold number of the edge nodes in the specified class has been identified by application of the SH model to the network, collecting respective data points and features from each of those edge nodes of the specified class; and building a final dataset that comprises the edge nodes of the specified class, and their associated data points and features, that were identified by application of the SH model to the network.

Embodiment 2. The method as recited in claim 1, wherein when the threshold number of the edge nodes of the specified class has not been reached, retraining the SH model with new data, and applying the retrained SH model to the network until the threshold number of edge nodes of the specified class has been reached.

Embodiment 3. The method as recited in claim 1, wherein the budget of k queries specifies a number of times that the network will be queried to identify edge nodes in the specified class.

Embodiment 4. The method as recited in claim 1, wherein applying the SH model to the network comprises applying the SH model to less than the entire network.

Embodiment 5. The method as recited in claim 1, wherein for purposes of applying the SH model to the network, the network is modeled as a partially observed graph.

Embodiment 6. The method as recited in claim 1, wherein the edge nodes in the final dataset all share a common domain.

Embodiment 7. The method as recited in claim 1, wherein the edge nodes in the final dataset are discovered without requiring application of the SH model to the entire network.

Embodiment 8. The method as recited in claim 1, wherein the SH model comprises a D3TS algorithm.

Embodiment 9. The method as recited in claim 1, wherein receiving respective sets of node features comprises receiving m node features from the edge nodes in the set of edge nodes, and m<<M, where M is a total number of nodes in the network.

Embodiment 10. The method as recited in claim 1, wherein the respective sets of node features each comprise one or more representative datapoints collected by the node from which the set of node features was received.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

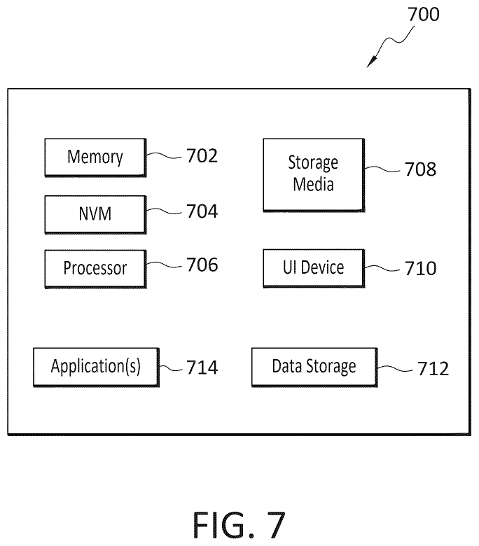

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving respective sets of node features from each edge node in a set of edge nodes of a network;
identifying those edge nodes in the set of edge nodes that contain datapoints corresponding to a specified class of edge nodes;
using the datapoints to train a selective harvesting (SH) model;
after the SH model has been trained, applying the SH model to the network, wherein the applying is constrained by a budget of k queries;
collecting datapoints from edge nodes in the specified class that were identified by the applying of the SH model to the network;
when a threshold number of the edge nodes in the specified class has been identified by application of the SH model to the network, collecting respective data points and features from each of those edge nodes of the specified class; and
building a final dataset that comprises the edge nodes of the specified class, and their associated data points and features, that were identified by application of the SH model to the network.

2. The method as recited in claim 1, wherein when the threshold number of the edge nodes of the specified class has not been reached, retraining the SH model with new data, and applying the retrained SH model to the network until the threshold number of edge nodes of the specified class has been reached.

3. The method as recited in claim 1, wherein the budget of k queries specifies a number of times that the network will be queried to identify edge nodes in the specified class.

4. The method as recited in claim 1, wherein applying the SH model to the network comprises applying the SH model to less than the entire network.

5. The method as recited in claim 1, wherein for purposes of applying the SH model to the network, the network is modeled as a partially observed graph.

6. The method as recited in claim 1, wherein the edge nodes in the final dataset all share a common domain.

7. The method as recited in claim 1, wherein the edge nodes in the final dataset are discovered without requiring application of the SH model to the entire network.

8. The method as recited in claim 1, wherein the SH model comprises a D3TS algorithm.

9. The method as recited in claim 1, wherein receiving respective sets of node features comprises receiving m node features from the edge nodes in the set of edge nodes, and m<<M, where M is a total number of nodes in the network.

10. The method as recited in claim 1, wherein the respective sets of node features each comprise one or more representative datapoints collected by the node from which the set of node features was received.

11. A non-transitory storage medium having stored therein instructions that are executable by one or more hardware processors to perform operations comprising:
receiving respective sets of node features from each edge node in a set of edge nodes of a network;
identifying those edge nodes in the set of edge nodes that contain datapoints corresponding to a specified class of edge nodes;
using the datapoints to train a selective harvesting (SH) model;
after the SH model has been trained, applying the SH model to the network, wherein the applying is constrained by a budget of k queries;
collecting datapoints from edge nodes in the specified class that were identified by the applying of the SH model to the network;
when a threshold number of the edge nodes in the specified class has been identified by application of the SH model to the network, collecting respective data points and features from each of those edge nodes of the specified class; and
building a final dataset that comprises the edge nodes of the specified class, and their associated data points and features, that were identified by application of the SH model to the network.

12. The non-transitory storage medium as recited in claim 11, wherein when the threshold number of the edge nodes of the specified class has not been reached, retraining the SH model with new data, and applying the retrained SH model to the network until the threshold number of edge nodes of the specified class has been reached.

13. The non-transitory storage medium as recited in claim 11, wherein the budget of k queries specifies a number of times that the network will be queried to identify edge nodes in the specified class.

14. The non-transitory storage medium as recited in claim 11, wherein applying the SH model to the network comprises applying the SH model to less than the entire network.

15. The non-transitory storage medium as recited in claim 11, wherein for purposes of applying the SH model to the network, the network is modeled as a partially observed graph.

16. The non-transitory storage medium as recited in claim 11, wherein the edge nodes in the final dataset all share a common domain.

17. The non-transitory storage medium as recited in claim 11, wherein the edge nodes in the final dataset are discovered without requiring application of the SH model to the entire network.

18. The non-transitory storage medium as recited in claim 11, wherein the SH model comprises a D3TS algorithm.

19. The non-transitory storage medium as recited in claim 11, wherein receiving respective sets of node features comprises receiving m node features from the edge nodes in the set of edge nodes, and m<<M, where M is a total number of nodes in the network.

20. The non-transitory storage medium as recited in claim 11, wherein the respective sets of node features each comprise one or more representative datapoints collected by the node from which the set of node features was received.
